(19) United States
(12) Patent Application Publication
(10) Pub. No.: US 2026/0112299 A1
(43) Pub. Date: Apr. 23, 2026

(54) CONTEXTUAL COLOR SELECTION FOR INFORMATION HANDLING SYSTEMS

(71) Applicant: Dell Products L.P., Round Rock, TX (US)

(72) Inventors: David Allen Dyson, Pflugerville, TX (US); Kai Wang, Shanghai (CN); Trent A. Buys, Seattle, WA (US)

(73) Assignee: Dell Products L.P., Round Rock, TX (US)

(21) Appl. No.: 18/922,983

(22) Filed: Oct. 22, 2024

(51) Int. Cl. G09G 3/20

(52) U.S. Cl. CPC G09G 3/2003; G09G 2320/0613; G09G 2320/066; G09G 2320/0666; G09G 2340/12; G09G 2354/00

(57) ABSTRACT

Systems and method provide color adjustments to content displayed by an Information Handling System (IHS). A request is detected for display of content in a graphical interface to be displayed by the IHS. Characteristics are determined for the physical environment in which the IHS is located, the user's operation of the IHS, and the content to be displayed. Based on the characteristics of the physical environment, the user operation and the content, adjustments are generated to the colors used to display the content. Through such context-based color adjustments, certain colors in content to be displayed may be modified to more contrasting colors, thus improving a user's ability to visually discern different portions of the content.

### FIELD

This disclosure relates generally to Information Handling Systems (IHSs), and more specifically, to the selection of colors that are displayed by IHSs.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs may support a variety of user I/O (Input/Output) capabilities, including the visual output of information to one or more display devices that are coupled to the IHS. An IHS may support integrated displays, such as in a laptop IHS. An IHS may support external displays, such as a display coupled to a desktop IHS, or a display of a docking station to which a laptop IHS is coupled, or a projection screen. Some user applications operating on an IHS may include graphical user interfaces that display content to the user, and in some instances may allow a user to edit the displayed content.

### SUMMARY

In various embodiments, systems and method provide color adjustments to content displayed by an Information Handling System (IHS). Embodiments may include: detecting a request for display of content in a graphical interface; determining characteristics of a physical environment in which the IHS is located; determining characteristics of a user's operation of the IHS; determining characteristics of the content to be displayed; generating adjustments to the colors used to display the content based on the physical environment characteristics, the user operation characteristics and the characteristics of the content to be displayed.

In some embodiments, the adjustments to the colors used to display the content comprise adjustments to a contrast between colors of the content in order to improve discernment between text and one or more images in the content. In some embodiments, the adjustments to the contrast between colors of the contents comprises a contrast adjustment between colors used for the display of at least a portion of the text and a first of the images on which the text is superimposed. In some embodiments, the characteristics of the physical environment in which the IHS is located comprise ambient lighting conditions in the physical environment. In some embodiments, the characteristics of the physical environment in which the IHS is located comprise ambient temperature conditions in a geographic area where the IHS is located. In some embodiments, the characteristics of the physical environment in which the IHS is located comprise a number of individuals other than the user that are detected in proximity to the IHS. In some embodiments, the characteristics of a user's operation of the IHS comprise an activity level of the user. In some embodiments, the activity level comprises a frequency of inputs to I/O (Input/Output) devices of the IHS. In some embodiments, the activity level comprises physical movements by the user as detected by one or more sensors of the IHS. In some embodiments, the adjustments to the colors used to display the content comprise changing the color of the text in relation to the activity level of the user. In some embodiments, the characteristics of the content to be displayed comprise mood classifications for one or more images included in the content. In some embodiments, the mood classifications of the one or more images is generated by a remote image classification service. In some embodiments, the adjustments to the colors used to display the content comprise adjustments to a color definition file used to display the content by a display device of the IHS. In some embodiments, the color definition file is utilized by a graphics processor of the IHS in rendering the content on the display device using the adjustments to the colors. In some embodiments, the adjustments to the colors used to display the content comprise changing the color of the text in relation to the mood classification for the one or more images included in the content.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) configured, according to some embodiments, for contextual selection of colors that are displayed by the IHS.

FIG. 2 is a swim lane diagram illustrating examples of components of a system configured, according to some embodiments, for contextual selection of colors that are displayed by an IHS.

FIG. 3A is a flowchart illustrating an example of a method, according to some embodiments, for contextual selection of colors that are displayed by an IHS.

FIG. 3B is a continuation of the flowchart of FIG. 3A.

### DETAILED DESCRIPTION

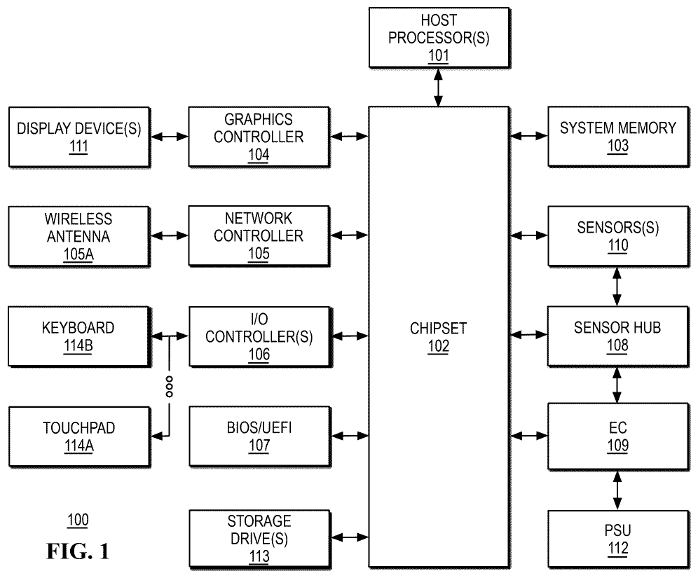

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail with regard to FIG. 1.

FIG. 1 is a diagram illustrating examples of components of an Information Handling System (IHS) 100 configured, according to some embodiments, to support contextual selection of colors that are displayed by the IHS. In some embodiments, IHS 100 may be a laptop computer that may display content to various display devices 111. For instance, a laptop IHS 100 may display content to: one or more displays that are integrated into one of the panels of the laptop, one or more external displays (e.g., displays of a docking station to which the laptop is coupled), a projector or other display intended for viewing by multiple individuals, an xR headset, etc. In each of these scenarios, a graphical user interface displays content generated by applications operating on the IHS. In some instances, the graphical user interface may provide a user of the IHS with capabilities for editing the content that is displayed. In scenarios where the user is editing content that is displayed, the user may select the color for some of this content, such as a user selecting the color of text to be displayed in a presentation. In some instances, these color selections may be made according to default color settings.

Whether selected by the user or using default selections, the colors selected for content displayed within a graphical user interface may provide poor contrast with other content that is also being displayed by that graphical user interface, such as the color of text added to a slide of a presentation contrasting poorly with a background of the slide and/or with an image that is also included in the slide, such as superimposing text on an image. Users may vary significantly in their selection of colors that provide adequate contrast with other content that is being displayed. Some users are particularly unable to choose contrasting colors that facilitate the visual discernment of the different content that is being displayed. In embodiments, an IHS 100 may be configured to support the automatic adjustment of such color selections in order to provide contrast between the different content that is displayed, where the color selections may be made based on various contextual factors, such as the operational context of the IHS's operations (e.g., characteristics of the physical environment), the context of the user's operation of the IHS and the context of the content itself.

As illustrated, IHS 100 includes host processor(s) 101. In various embodiments, IHS 100 may be a single-processor system, a multi-processor system including two or more processors and/or processor cores. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). IHS 100 utilizes a chipset 102 that may include one or more integrated circuits that are connected to processor 101. In the embodiment of FIG. 1, processor 101 is depicted as separate component from chipset 102. In other embodiments, all of chipset 102, or portions of chipset 102 may be implemented directly within the integrated circuitry of the processor 101. Chipset 102 provides the processor(s) 101 with access to a variety of resources of the IHS.

In some embodiments, processor 101 may include an integrated memory controller that may be implemented directly within the circuitry of the processor 101, or the memory controller may be a separate integrated circuit that is located on the same die as the processor 101. The memory controller may be configured to manage the transfer of data to and from the system memory 103 of the IHS 100 via a high-speed memory interface. The system memory 103 provides the processor 101 with a high-speed memory that may be used in the execution of computer program instructions by the processor 101. Accordingly, system memory 103 may include memory components, such as such as static RAM (SRAM), dynamic RAM (DRAM), NAND Flash memory, suitable for supporting high-speed memory operations by the processor 101. In certain embodiments, system memory 103 may combine both persistent, non-volatile memory and volatile memory. In certain embodiments, the system memory 103 may be comprised of multiple removable memory modules.

As illustrated, a variety of resources may be coupled to the processor(s) 101 of the IHS 100 through the chipset 102. For instance, chipset 102 may be coupled to a wireless network controller 105 that may support different types of wireless network connectivity. In certain embodiments, wireless network controller 105 may include one or more Network Interface Controllers (NICs). In some embodiments, wireless network controller 105 may implement hardware for communicating via a specific networking technology, such as Wi-Fi, BLUETOOTH, and mobile cellular networks (e.g., CDMA, TDMA, LTE). In some embodiments, network controller 105 may support wireless Wi-Fi communications, and my include a Wi-Fi controller or wireless NIC card by which IHS 100 transmits and receives wireless Wi-Fi signals.

In some embodiments, the wireless signaling utilized by wireless network controller 105 may be implemented using multiple wireless antenna 105a. In transmitting and receiving wireless signals using multiple antenna 105a, the strength of signals that are received by each of these antenna 105a may be analyzed to provide directional information regarding the environment in which the wireless signals are propagated. In some embodiments, the directional information that is used in the transmission and reception of wireless signals from each of the antenna 105a may be used to detect the presence of the user of the IHS 100 relative to the position of the IHS itself. As described in additional detail below, in some embodiments, such user presence detection information may be utilized in identifying the number of individuals, other than the user, that are currently in proximity to the IHS 100. Embodiments may then utilize this information in selecting adjustments to the colors that are used by the IHS 100 in displaying content, where the adjustments may include selection of contrasting colors within the content to be displayed such that different portions of the content (such as text and images) are discernable from each other such that the content is now suitable for viewing by a particular number of individuals. As described in additional detail below, various other characteristics of the physical environment in which the IHS is operating may be included as inputs to the selection of colors displayed by IHS 100.

Returning to the hardware and software of an IHS according to embodiments, chipset 102 also provides processor 101 with access to one or more storage drives 113. In various embodiments, storage drives 113 may be integral to the IHS, or may be external to the IHS 100. In some embodiments, storage drive(s) 113 may be accessed via a storage controller that may be an integrated component of the storage device. In some embodiments, a storage controller may be a system-on-chip function of processor(s) 101. Storage drive(s) 113 may be implemented using any memory technology allowing IHS 100 to store and retrieve data. For instance, storage drive(s) 113 may be a magnetic hard disk storage drive or a solid-state storage drive. In certain embodiments, storage drive(s) 113 may include a system of storage devices, such as a cloud drive accessible via network interface 105.

As illustrated, IHS 100 also includes a BIOS (Basic Input/Output System) 107 that may be stored in a non-volatile memory accessible by chipset 102. In some embodiments, BIOS 107 may be implemented using a dedicated microcontroller coupled to the motherboard of IHS 100. In some embodiments, BIOS 107 may be implemented as operations of embedded controller 109. Upon powering or restarting IHS 100, processor(s) 101 may utilize BIOS 107 instructions to initialize and test hardware components coupled to the IHS 100. The BIOS 107 instructions may also load an operating system for use by the IHS 100. The BIOS 107 provides an abstraction layer that allows the operating system to interface with certain hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI.

As described, one or more display devices 111 may be coupled to IHS 100. Display device(s) 111 may include a plurality of pixels that are arranged in a matrix and are configured to display visual information. Display device(s) 111 may include Liquid Crystal Display (LCD), Light Emitting Diode (LED), organic LED (OLED), or other thin film display technologies. IHS 100 may support an integrated display device, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays, such as external monitors that may be coupled to IHS 100 via various types of couplings. External displays that are supported by IHS 100 may also include a projection display. The external displays of an IHS 100 may also include wearable displays, such as displays integrated within VR headsets.

In some embodiments, one or more of the display devices 111 may be capable of receiving touch inputs from a user. In some embodiments, these touch inputs received via display devices 111 may be processed by a touch controller that may be separate from other controllers used the display of content. In some embodiments, the touch controller functions may be implemented by a display controller. In some embodiments, touch controller may be an embedded component of an individual display device 111, such that IHS 100 may support multiple distinct touch controllers, each processing inputs from a separate display device 111, such as integrated touch controllers processing inputs from separate display panels of a laptop IHS.

In some embodiments, chipset 102 may operate the one or more display device(s) 111 via a graphics processor and/or GPU (Graphics Processor Unit) 104. In certain embodiments, a graphics processor 104 may be comprised within a video or graphics card or within an embedded controller installed within IHS 100. In certain embodiments, a graphics processor 104 may be integrated within processor 101, such as a component of a system-on-chip. As described in additional detail below, the GPU 104 may utilize one or more color definition files, such as ICC (International Color Consortium) or ICM (Image Color Management or Input Characterization Model) files, that define the display of specific colors by a specific device, such as by a specific display device 111 of an IHS. The color definition file specifies color characteristics of a specific display device 111 and provides instructions for use by a GPU 104 for converting colors of content to be displayed to a color space that is supported by the display device 111. In some instances, the operating system of the IHS 100 may manage a library of supported color definition files that may selected based on the content that is to be displayed and based on the display device 111 that will be used to display the content. As described in additional detail below, in embodiments, the selection of the color definition file to be used and/or adjustments to the color definitions include in a color definition file may be based on contextual inputs, such as the context in which the IHS 100 is operating, the context of the user's operation of the IHS 100 and the context of the content that is to be displayed. Based on such color definition file selections and/or adjustments, embodiments may select the use of contrasting colors for the display of content, thus improving the ability for individuals in proximity to the IHS 100 to discern different portions of the content.

Chipset 102 may also provide access to one or more user input devices, in some instances using one or more I/O controller(s) 106 or the like. Examples of user input devices include, but are not limited to a touchpad (such as a touchpad integrated in the palm rest area of a laptop IHS), keyboard 114B and mouse 114C. In some embodiments, a single controller may support multiple of these user input devices, such as a keyboard controller that detects inputs from the keyboard 114B and also detects inputs from a touchpad 114 integrated in the palm rest, and also detects mouse 114C inputs detected by buttons included on or under a palm rest of an laptop IHS 100. In some embodiments, other user input devices supported through the operation of I/O controller(s) 106 may include a stylus, microphone(s) and camera(s) that may each be integrated or external components of an IHS 100.

Some IHS 100 embodiments may utilize an embedded controller 109 that may be a motherboard component of IHS 100 and may include one or more logic units. In certain embodiments, embedded controller 109 may operate from a separate power plane from the main processors 101 of IHS, and thus from the operating system functions of IHS 100. In some embodiments, firmware instructions utilized by embedded controller 109 may be used to operate a secure execution environment that may include operations for providing various core functions of IHS 100, such as power management and management of certain operating modes of IHS.

For instance, embedded controller 109 may implement operations for interfacing with a power supply unit (PSU) 112 in managing power for IHS 100. In certain instances, the operations of embedded controller may determine the power status of IHS 100, such as whether IHS 100 is operating strictly from battery power, whether any charging inputs are being received by power supply unit 112, and/or the appropriate mode for charging the one or more battery cells of the IHS using the available charging inputs. Embedded controller 109 may support routing and use of power inputs received via a USB port and/or via a power port supported by the power supply unit 112. In addition, operations of embedded controller 109 may interoperate with power supply unit 112 in order to provide battery status information, such as the state of charge of the battery.

In some embodiments, embedded controller 109 may also implement operations for detecting certain changes to the physical configuration of IHS 100 and managing the modes corresponding to different physical configurations of IHS 100. For instance, where IHS 100 is a laptop computer or a convertible laptop computer, embedded controller 109 may receive inputs from a lid position sensor that may detect whether the two sides of the laptop have been latched together, such that the IHS is in a closed position. In response to lid position sensor detecting latching of the lid of IHS 100, embedded controller 109 may initiate operations for shutting down IHS 100 or placing IHS in a low-power mode. In this manner, IHS 100 may support the use of various power modes.

In managing the operation of IHS 100 according to its physical posture, embedded controller 109 may identify any number of IHS physical postures, including, but not limited to: laptop, stand, tablet, or book postures. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user. In some embodiments, the physical posture of a convertible IHS may be utilized as an input to a color selection model, where this physical posture is an additional context of the IHSs operation. For instance, a physical posture input to the color selection model may result in color adjustments when the IHS is in a landscape posture in a room with bright ambient light, thus causing glare, while making no adjustments when in a similar ambient light environment while configured in a kickstand posture, due to lower levels of glare when in this posture.

IHS 100 may include a wide variety of sensors 110 for use in gathering telemetry data that can be used in the management of operations by the IHS, and in embodiments, for describing the context of the IHS's 100 current operations, where this context information may be used in the selection and/or adjustments of the color definitions to be used for the display of content. Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s). Sensors 110 may include geo-location sensors capable for providing a geographic location for IHS 100, such as a GPS sensor or other location sensors configured to determine the location of IHS 100 based on triangulation and network information. Various sensors, such as optical, infrared and sonar sensors, may be used in the detection of individuals in proximity to the IHS 100 and/or in other forms of user presence detection. In some embodiments, user presence detection may be provided using a combination of sensor 110 information and using wireless signal information and collected by network controller 105. In some embodiments, user presence detection capabilities of the IHS 100 may indicate a specific number of individuals within proximity to the IHS 100 and/or to the display device 111 that will be used for display of content. Embodiments may utilize such information describing the number and position of individuals relative to the IHS and/or display device 111 in the selection and/or adjustments of the color definitions to be used for the display of content.

In some embodiments, sensor hub 108 may utilize data from inertial movement sensors, that may include accelerometer, gyroscope, and magnetometer sensors, to determine the current orientation and any movement of IHS 100 (e.g., IHS 100 is motionless on a relatively flat surface, IHS 100 is being moved irregularly and is likely in transport, the hinge of IHS 100 is oriented in a vertical direction). In certain embodiments, the sensor hub 108 may also include capabilities for determining a location and movement of IHS 100 based on triangulation of network signal and based on network information provided by the OS or by a network interface.

In some embodiments, an IHS 100 may not include all of the components shown in FIG. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as systems-on-a-chip.

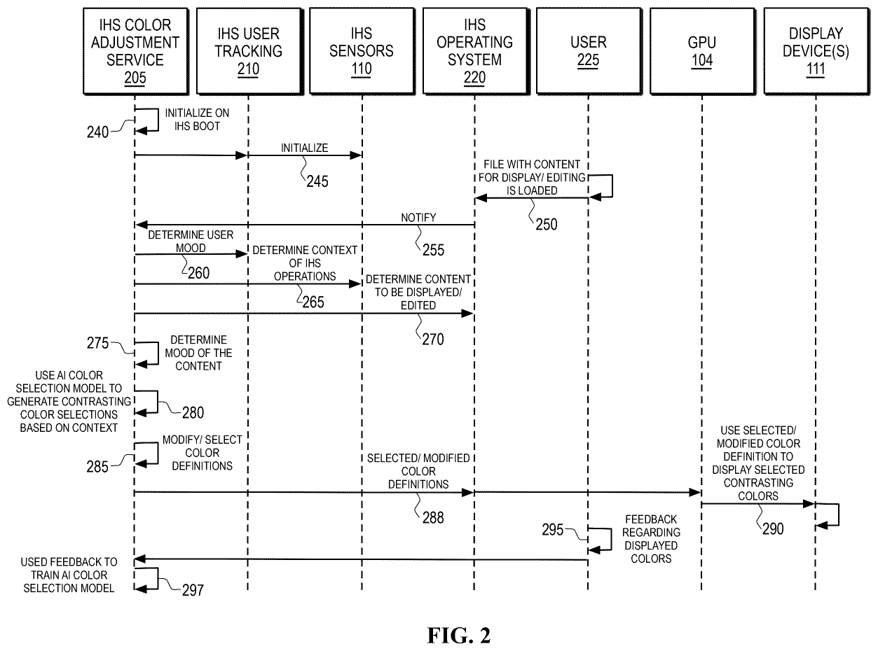

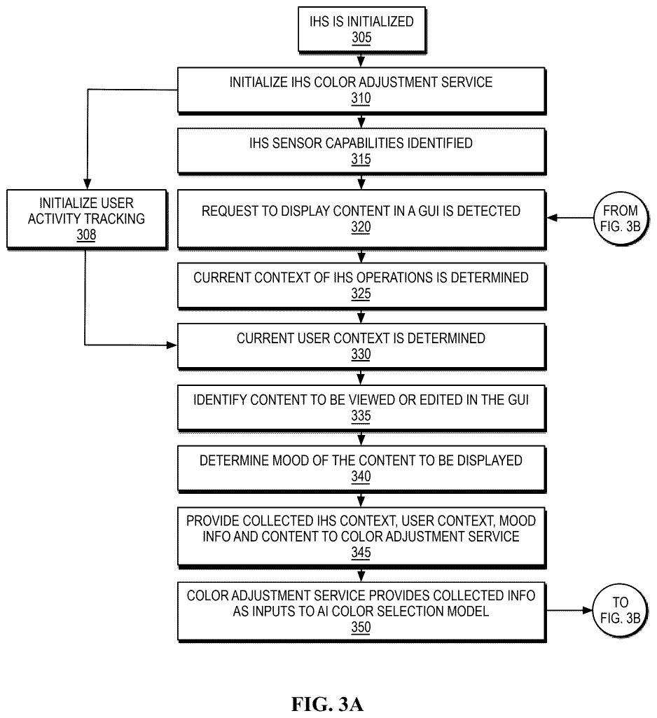

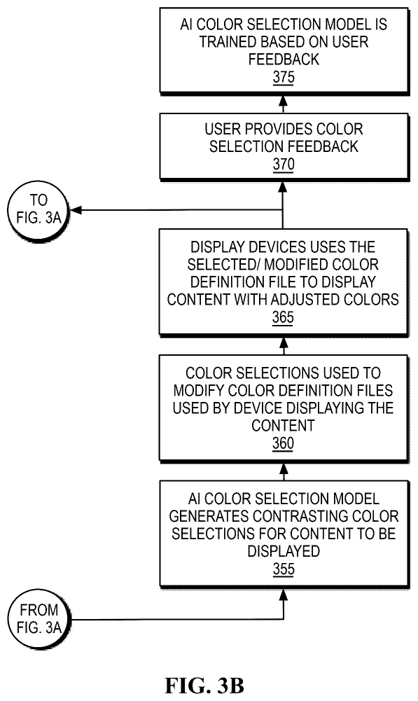

FIG. 2 is a diagram illustrating additional examples of components of a system configured, according to some embodiments, to support for contextual selection of colors that are displayed by an IHS, such as IHS 100 described with regard to FIG. 1. FIGS. 3A and 3B are a flowchart illustrating an example of a method, according to some embodiments, for contextual selection of colors that are displayed by an IHS 100. Embodiments may begin, at 305, with the initialization of an IHS 100, such as upon booting or restarting the IHS. In some embodiments, upon initialization of an IHS, instructions to be loaded for use by hardware components of the IHS, such as firmware and other settings, may be validated as authentic based on comparisons of the instructions to be loaded against reference signatures corresponding to authentic instructions. Upon successful validation of such instructions, one or more of the hardware components of the IHS 100 may load validated instructions and may thus operate based on execution of these trusted instructions.

In some embodiments, this validated firmware to be loaded by components of the IHS 100 may include firmware for use in monitoring contextual factors used in the selection of colors to be used in the display of content, such as user presence detection capabilities that are implemented based on validated firmware operations of a network controller 105 and/or sensor hub 108. In some embodiments, the validated firmware instructions may include validated firmware for use by GPU 104 and/or display devices 111, where this firmware may be adapted to interoperate with an IHS color adjustment service 205 that operates on the IHS and that may select and/or adjust the color definitions to be used by the GPU 104 and display devices 111 for the display of content in a manner that utilizes contrasting colors within the displayed content, where the contrast in colors is selected based on contextual logical and physical characteristics of the IHS's current operations, as well as based on various other contextual factors, such as based on ambient weather conditions, activity levels of the user, ambient weather conditions, and the mood, tone or other emotive classification of the content to be displayed.

Once firmware instructions have been validated, further initialization may include initiating the IHS 100 boot sequence and loading operating system instructions. Once a requisite amount of instructions have been loaded and the IHS is in operation, at 310 and at 240, embodiments may initialize and configure a color adjustment service 205 that will operate on the IHS, in some instances as a background service of the operating system 220. In some embodiments, the color adjustment service 205 may be operated by an embedded controller 109 of the IHS, where the embedded controller interfaces with the operating system of the IHS and with the GPU 104 in making color adjustments. In some embodiments, the embedded controller 109 may interface with the sensor hub 108 in collecting and evaluating context information, such as in user presence detection determinations, that may be used as inputs to an color selection model that makes selections and/or adjustments to the color definitions to be used in displaying specific content to one or more of the display devices 111 coupled to the IHS.

As indicated in FIG. 2, at 245, once the color adjustment service 205 has been initiated, additional capabilities of the IHS may subsequently be initialized for use in generating context-based color adjustments to content displayed by the IHS. In some embodiments, at 308 of FIG. 3A, the color adjustment service initializes a service 210 for tracking indications of the activity level of the user 225 of the IHS, which may serve as an indication of the mood or other emotive state of the user. In some embodiments, the user tracking service 210 may operate as a background service of the operating system 220. In some embodiments, the user tracking service 210 may be operated by the embedded controller 109, which interfaces with the sensor hub 108 in collecting and evaluating information that provides indications of the user's activity level and/or emotive state. In some embodiments, embedded controller 109 may interface with I/O controllers 106 of the IHS in tracking key stroke frequency and mouse inputs that indicate different levels of activity by the user 225. In such embodiments, the input activity levels of the user may be indicative of the emotive state of the user, which such emotive determinations may be used to adjust the colors used in displaying content.

In some embodiments, the user tracking service 210 may interface with sensor hub 108 in tracking user presence information that is indicative of different levels of activity by the user 225, and thus indicative of the emotive state of the user. For instance, sensor hub 108 may be used on tracking the frequency and size of the user's movements relative to the IHS (e.g., tracking physical gestures by the user) and/or movements by the user 225 within the physical environment in which the IHS is located (e.g., user is sitting, standing, pacing relative to the position of the IHS). In some embodiments, sensor hub 108 may be used in monitoring physical characteristics of the user 225 such as pupil tracking that provide indications of levels of physical activity by the user, and providing indications of the user's emotive state. In some embodiments, sensor hub 108 may determine a level of activity of the user 225 based on information received from wearable sensors, or other sensors in physical contact with the user, that are accessible by the IHS 100, such as smart watches, VR headsets, gaming controllers, etc.

As indicated in FIG. 2, in addition to initiating of the user tracking service 210, at 245, the color adjustment service 205 may initialize use of various IHS sensor 110 inputs. As with the use of sensors 110 by the user tracking service 210, the color adjustment service 205 may rely on the embedded controller 109 and/or sensor hub 108 in interfacing and evaluating information collected by sensors 110 for use in providing context information describing the physical environment in which the IHS 100 is operating. For instance, sensors 110 of the IHS may be used in tracking ambient lighting characteristics in the vicinity of the display device(s) 111 to which content will be displayed. Higher ambient lighting levels detected by the IHS 100 may result in color adjustments that increase the contrast between text and images in the content, thus counteracting the effects of glare caused by ambient lighting. Similarly, lower ambient lighting levels may result in color adjustments that reduce contrast between text and images in the content in a manner that reduces overall brightness of the displayed content in order to promote uniform ambient and displayed brightness that reduces eye strain. However, the detection of low ambient lighting below a certain threshold may result in increasing the contrast between text and images in the content, thus promoting the ability to discern the text from the images without having to boost screen brightness of the display device 111, which requires use of additional energy.

In some embodiments, sensors 110 of the IHS may be used in detecting individuals other than the user 225 that are in proximity to the IHS and/or individuals in proximity to a display device 111 to be used in the display of content. For instance, the detection of individuals other than the user 225 that are in proximity to the IHS, and thus in proximity to an integrated display of the IHS, may result in color adjustments that increase the contrast used between images and text that are displayed, thus improving the ability of individuals further away from the display device 111 to discern the text from the images. In scenarios where the content is to be displayed to an external display or projection screen for viewing by multiple individuals that are detected in proximity to the IHS, the resulting color adjustments may further increase the contrast between images and text, thus further improving the ability for individuals throughout the room or area to discern the text from the images.

With such sensor capabilities to be utilized in tracking IHS and user characteristics initialized, the operating system 220 of the IHS is configured to detect, at 320, requests to display content via a graphical interface, such as a graphical interface supported by the operating system 220 of the IHS and/or by an application running within the operating system. In some embodiments, at 250, the operating system may detect the loading of a file that includes content to be displayed, and in some instances edited, by the user 225. In some instances, the request for display of content may be initiated by the user 225, such as a user selecting an image, presentation or document that is available within a local or remote file system of the IHS 100. In some instances, the request for display of content may be initiated automatically, such as the operating system 220 automatically launching an application that includes a default graphical interface, or that restores a previously viewed graphical interface. In some embodiments, the request for display of content may include a request for the display and also possible editing of the content, such as though the user opening a file that allows the user to edit the content that is displayed, such as though a user opening a file supported by a presentation or word processing application.

As indicated in FIG. 2, the request for display of content may be detected by the IHS operating system 220, such as by a background process that monitors for the launching of applications that include user interfaces and further monitors for loading of files by these applications that will result in the display of content. In response to detecting a request for display of content, at 255, the operating system 220 may notify the color adjustment service 205 of the request. In response, at 325, the color adjustment service 205 initiates adjustments to the colors to be used in the display of the content by determining the current operating context of the IHS 100, such as characteristics of the physical environment in which the IHS is located. As described above and as indicted in FIG. 2, at 265, the color adjustment service 205 may rely on one or more sensors 110 of the IHS in order to generate measurements of various characteristics of the physical environment in which the IHS is located, such as to measure ambient light levels in the vicinity of the IHS, to measure the color of the ambient light and to distinguish between natural versus artificial ambient light shining towards the display device 111 to be used in the display of the content.

In some embodiments, the characteristics of the physical environment may also include characteristics of the room or area in which the IHS is located. For instance, embodiments may generate different color adjustments for display of content within a larger room, such as a conference room, versus within a smaller area, such as within a cubicle. As described above, in some embodiments, the characteristics of the physical environment may include the presence of individuals other than the user 225 in physical proximity to the IHS and/or to the display device 111 to be used in the display of the content. In some embodiments, the characteristics of the physical environment may include weather conditions in the geographic area in which the IHS 100 is located. In such embodiments, different color adjustments color adjustments made by an color selection model may be generated to correspond to the current weather conditions, such as to adjust to the use of cooler color tones in response to colder weather conditions and the use of warmer color tones in hotter weather conditions.

As described above, embodiments may initialize, or register as a subscriber of, a user activity tracking capability 210 of the IHS that may run as a background process. While operating as a background process, the user activity tracking 210 service may monitor for inputs by the user 225 to I/O devices of the IHS 100, such as tracking the frequency of keyboard, mouse and/or touchscreen inputs by the user 225. Through monitoring of such inputs, embodiments may generate a profile of inputs by the user over time, with the profile being used to identify periods with the highest frequency of inputs by the user and to identify a baseline frequency of inputs by the user that is indicative of normal operations by the user. This profile of the user's inputs may then be utilized, at 260, to determine whether the current frequency of user inputs corresponds to a high, normal or low frequency of inputs by the user 225. In response to low activity by the user, color adjustments made by an color selection model may decrease the contrast between colors used in the display of content and may increase the contrast between these colors in response to high activity by the user.

As described, user activity tracking 210 may additionally or alternatively track various physical characteristics of the user through sensors incorporated in devices worn by the user 225, such as temperature, pulse and other biometric information that are indicative of the user's current activity level and/or emotive state. In some embodiments, sensor 110 such as photographic and infrared cameras of the IHS may be used in tracking eye movements by the user 225, thus providing an additional indicator of the user's activity level and/or emotive state. Based on the collection of such user information, color adjustments made by an color selection model may adjust colors used in the display of content such that the colors that are used by the display device 111 are indicative of a user's current emotive state.

The illustrated embodiment continues, at 335 and 270, with the identification of the content to be displayed, and in some instances also edited by the user 225. In some instances, the content to be displayed may be solely textual, such as the user opening a text file with a word processing application. In such instances, the graphical interface of the word processing application may support the use of various different colors for the display of this text and for the background on which the text is displayed. In such scenarios, embodiments may adjust the colors used for the background and for some or all of the text in order to adjust the contrast of the text relative to the background, thus improving the readability of the text. In some instances, the content to be displayed may include a combination of text and images, such as within a slide of a presentation that is to be displayed. In such scenarios, color adjustments made by an color selection model may adjust the colors used for the text and/or images in order to adjust the contrast of the text relative to these images, thus improving the ability of individuals to discern the text from the images. In some instances, the content to be displayed may include a combination of multiple images. In such scenarios, embodiments may adjust the colors used for each of these images in order to adjust the contrast of the these images relative to each other, thus improving the ability of individuals to discern the images as being separate.

At 340 and at 275, embodiments may determine a mood or other emotive classification of images that are included in the content to be displayed. For instance, embodiment may rely on an image classification service, such as an AI model that has been trained in the evaluation and classification of images according to the mood or other emotive description of the image. For instance, the image classification model may classify an image of a bucolic farm landscape, or of an nature scene or an animal sleeping as representing a tranquil mood. This same image classification model may classify an image of an industrial scene, a city skyline or an automobile as representing an active mood. The same image classification model may classify an image of person exercising, an explosion, a running animal or an extreme weather event as representing an excited mood. Embodiments may adjust colors used in the display of content such that the colors that are used by the display device 111 are indicative of the mood of the images included in the content. For instance, embodiments may adjust the color of text that is to be displayed along with an image in order to increase the contrast of the text from the image, where the level of contrast and/or color selection for the text may be commensurate with the mood of the image. In this manner, brighter colors with greater contrast may be selected for text to be displayed along with an image of an exited mood, while more soothing colors with lesser contrast may be selected for the display with an image of a tranquil mood.

As indicated, at 280 and at 345, the mood information for the content, the current context of the IHS's operations and the current context of the user's operation of the IHS are provided as inputs to the color adjustment service 205 for use in making adjustments to the colors to be used for the display of this content. In some embodiments, the color adjustment service 205 may rely on an AI color selection model for making these adjustments. For instance, at 350, an AI color selection model may be a neural network that receives the collected context information as inputs to individual nodes of an input layer of the neural network. For instance, one or more input nodes of the AI color selection neural network may receive inputs representing the current mood and/or activity level of the user 225. In some instances, an input to such a node may represent a mood or other emotive classification of the user, such as a classification of the user as tranquil, normally active, very busy or agitated (such as in scenarios where biometric sensor data is available). In some instances, rather than classifications of the user activity data, input nodes may be used that receive some or all of the collected user activity data as inputs, such as a measure of the current frequency of user I/O inputs, or the current pulse or blood pressure of the user 225.

Other inputs to the AI color selection neural network may include inputs that represent characteristics of the physical environment in which the IHS 100 is located. For instance, one or more input nodes of the AI color selection neural network may receive inputs representing the number of individuals other than the user 225 that are in proximity to the IHS. These inputs to the AI color selection neural network may also specify the average or median distance of these individuals from the IHS and/or from the display device 111 to which the content will be displayed. Input nodes to the AI color selection neural network may also received inputs regarding the size of the room or area in which the IHS is located, such as an approximate size of a conference room or office in which the IHS is located, where this size may be approximated based on measurements sensor hub 108.

In some embodiments, input nodes of the color selection neural network may also receive inputs regarding the ambient lighting characteristics in the vicinity of the IHS. For instance, an input node may receive a lux or illuminance value that may be measured directly by sensors 110 of the IHS, or that may be calculated by a sensor hub 108 based on measurements from multiple sensors 110. In some embodiments, the ambient lighting inputs to the AI color selection neural network may include measurements of the color and/or intensity of the ambient light detected by sensors of the IHS.

Inputs to the AI color selection neural network may also include one or more nodes representing the mood or other emotive classification of the content to be displayed. As described, image classification services may be used on classifying the mood of content to be displayed, such as based on AI evaluation of images to be displayed. Accordingly, inputs to the AI color selection neural network may include classifications of the mood of one or images included in the content, such as a classification of images as tranquil, active or exciting, where such classifications may be input as values within a numerical range, or may be input as text classifications that are evaluated by the AI color selection neural network and incorporated into its model through natural language processing.

Based on a set of such inputs to the nodes of the input layer, at 285 and 355, the AI color selection neural network generates outputs that correspond to adjustments to the display of colors that are included in the content to be displayed, such as through the selection and/or modification of a color definition file or through other modifications to color settings used by a GPU 104 and/or display device 111. In some embodiments, the outputs of the AI color selection neural network may include one or more nodes the output modifications to the RGB color space to be used by the GPU 104 in rendering the content on the display device 111. In some embodiments, at 360, the outputs of the AI color selection neural network may include an adjusted color definition file to be used by the GPU 104 in rendering the content on the display device 111.

As described above, the color space to be used by a display device 111 may be specified within a color definition file such as an ICM or ICC file. Based on the color definitions in such a file, the GPU 104 may select the colors to be rendered by device 111. In some embodiments, the color definition file that is supported by the display device 111 to be used in the display of the content may also be provided as an input to the AI color selection neural network. In such embodiments, the outputs of the AI color selection neural network may include an adjusted color definition file, where the adjustments in this file may modify the RGB outputs to be used in the display of one or more colors included in the content.

In some embodiments, the AI color selection neural network may be provided a library of available color definition files that are supported by the display device 111, where the library of files may be provided as inputs to one or more nodes. Based on a color definition file library as in input, the color selection model generates an output that selects the most appropriate of these color definition files based on the current context. In some embodiments, the operating system 220 may maintain a library of all color definition files that are supported by the IHS 100 for use in displaying content to supported display devices 111. Accordingly, in some embodiments, in addition to specifying the content to be displayed, at 270, the operating system may provide the color adjustment service 205 with the color definition files that are supported by the display device 111 that will be used to display this specific content, with the operating system 220 being aware of the specific display device to which the content will be displayed, whether it be an integrated display, a external monitor, a gaming VR headset, a projection screen, etc.

Through such outputs, the AI color selection neural network may generate color adjustments that improve readability of the specific content, while accounting for the specific physical environment in which the IHS is located and reflecting various contextual factors, such as the ambient conditions, other individuals in the area, the activity level of the user 225 and the mood of the content itself. Once the selection and/or modifications to the color definitions or other color settings have been generated as outputs by the AI color selection neural network, at 288, the color adjustment service 205 transmits the selected and/or modified color definition file to the operating system 220 of the IHS. In turn, the operating system 220 may configure the GPU 104 for use of the selected/modified color definition file to display the content in the display device 111, with this color definition file providing contrasting color selections in the display of the content in order to improve the ability to discern portions of the content from each other, such as discerning text that is superimposed on an image within the content.

Using the color definition file that was modified and/or selected by the AI color selection neural network, at 290 and 365, the content is rendered by the display device 111. As described, the color definition file may specify adjustments to the colors to be used in displaying the content, where this adjustments may increase the contrast between images and text included in the displayed content, thus improving the ability for the user 225, and potentially other individuals in proximity to the IHS, to discern the various items that are being displayed, such as discerning text from images, or discerning two images from each other.

For instance, a file to be opened and displayed by an application running in the operating system 220 may include a dark colored image of a nature scene, such as a scene including a lake with deep blue water. This file may also include text that is overlayed or otherwise superimposed in a sperate layer on top of that image. In the original content, the text may be a deep, dark red color. For a user 225 that is close to the display device 111 and in normal ambient lighting conditions, the dark red text may be sufficiently discernable over the blue water of the image. However, once this content is displayed for more individuals via a conference room projector and/or when lighting conditions change resulting in glare on the display device 111, the dark red text is not easily discernable from the blue water.

Accordingly, in embodiments, the color adjustment service 205 may adjust the color of the dark red text, where the selected color for the text improves the contrast from the blue water over which the text is to be displayed, and where the selected color is chosen based on several contextual factors. For instance, based on inputs specifying ambient lighting that is conducive to glare and the display of content to an external display monitor 111 with multiple individuals other than the user 225 in proximity to the IHS, the AI color selection neural network may modify the color definition file to be used such that this deep dark red color of the text is instead displayed as a bright red that is more easily discernable from the blue water. In some embodiments, the AI color selection neural network may modify the color definition file to generate still greater contrast such that this deep dark red color of the text is instead displayed as a bright yellow, where this greater contrast may reflect an active or excited activity level of the user, such as generated by the user tracking server 210 and provided as an input to the AI color selection neural network, or such as in the display device 111 being a projector being used in a large with many individuals, or in response to an classification of the mood of the natural landscape image as exciting, such as due to a large fish jumping out of the water. Through such modifications to the color definition file, the AI color selection neural network may make targeted modifications to particular colors used in the content to be displayed, thus improving the ability to discern objects comprises of those particular colors from other content that is being displayed.

Once the selected and/or modified color definition file has been used in display of the content, as indicated in FIG. 2, embodiments may continue, at 295 and 370, with the user 225 providing feedback related to the color selections made by the color adjustment service 205. In some embodiments, the color adjustment service 205 and operating system 220 may interoperate in providing the user 225 with an ability to approve or disapprove of color adjustments made to displayed content. In scenarios where the user 225 does not disapprove or otherwise object to the color adjustments, at 297, the color adjustment service 205 may infer this as implied positive feedback in training, at 375, the AI color selection neural network to continue making similar color adjustments. In scenarios, where the user 225 does not approve of the color adjustments, that feedback is also provided to the AI color selection neural network, thus decreasing the likelihood of a similar color adjustment being made in the future. In some embodiments, any disapproval by the user may immediately revert, at 320, to evaluation of the current context information and initiation of another iteration of the described process for adjusting the colors used to display the content, with the AI color selection neural network now modified to avoid making similar color adjustments to those explicitly disapproved of by the user 225.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination of thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method for color adjustments in content displayed by an Information Handling System (IHS), the method comprising:
detecting a request for display of content in a graphical interface;
determining characteristics of a physical environment in which the IHS is located;
determining characteristics of a user's operation of the IHS;
determining characteristics of the content to be displayed;
generating adjustments to the colors used to display the content based on the physical environment characteristics, the user operation characteristics and the characteristics of the content to be displayed.

2. The method of claim 1, wherein the adjustments to the colors used to display the content comprise adjustments to a contrast between colors of the content in order to improve discernment between text and one or more images in the content.

3. The method of claim 2, wherein the adjustments to the contrast between colors of the contents comprises a contrast adjustment between colors used for the display of at least a portion of the text and a first of the images on which the text is superimposed.

4. The method of claim 1, wherein the characteristics of the physical environment in which the IHS is located comprise ambient lighting conditions in the physical environment.

5. The method of claim 1, wherein the characteristics of the physical environment in which the IHS is located comprise ambient temperature conditions in a geographic area where the IHS is located.

6. The method of claim 1, wherein the characteristics of the physical environment in which the IHS is located comprise a number of individuals other than the user that are detected in proximity to the IHS.

7. The method of claim 1, wherein the characteristics of a user's operation of the IHS comprise an activity level of the user.

8. The method of claim 7, wherein the activity level comprises a frequency of inputs to I/O (Input/Output) devices of the IHS.

9. The method of claim 7, wherein the activity level comprises physical movements by the user as detected by one or more sensors of the IHS.

10. The method of claim 7, wherein the adjustments to the colors used to display the content comprise changing the color of the text in relation to the activity level of the user.

11. The method of claim 1, wherein the characteristics of the content to be displayed comprise mood classifications for one or more images included in the content.

12. The method of claim 11, wherein the mood classifications of the one or more images is generated by a remote image classification service.

13. The method of claim 1, wherein the adjustments to the colors used to display the content comprise adjustments to a color definition file used to display the content by a display device of the IHS.

14. The method of claim 13, wherein the color definition file is utilized by a graphics processor of the IHS in rendering the content on the display device using the adjustments to the colors.

15. The method of claim 11, wherein the adjustments to the colors used to display the content comprise changing the color of the text in relation to the mood classification for the one or more images included in the content.

16. An Information Handling System (IHS) comprising:
one or more processors; and
one or more memory devices coupled to the one or more processors, the memory devices storing computer-readable instructions that, upon execution by the one or more processors, cause the first IHS to:
detect a request for display of content in a graphical interface;
determine characteristics of a physical environment in which the IHS is located;
determine characteristics of a user's operation of the IHS;
determine characteristics of the content to be displayed;
generate adjustments to the colors used to display the content based on the physical environment characteristics, the user operation characteristics and the characteristics of the content to be displayed.

17. The IHS of claim 16, wherein the adjustments to the colors used to display the content comprise adjustments to a contrast between colors of the content in order to improve discernment between text and one or more images in the content.

18. The IHS of claim 16, wherein the adjustments to the colors used to display the content comprise adjustments to a color definition file used to display the content by a display device of the IHS.

19. A computer-readable storage device having instructions stored thereon for context-based color adjustments by a first IHS (Information Handling System), wherein execution of the instructions by one or more processors of the first IHS causes the one or more processors to:
detect a request for display of content in a graphical interface;
determine characteristics of a physical environment in which the IHS is located;
determine characteristics of a user's operation of the IHS;
determine characteristics of the content to be displayed;
generate adjustments to the colors used to display the content based on the physical environment characteristics, the user operation characteristics and the characteristics of the content to be displayed.

20. The computer-readable storage device of claim 19, wherein the adjustments to the colors used to display the content comprise adjustments to a contrast between colors of the content in order to improve discernment between text and one or more images in the content.
